(19) United States
(12) Patent Application Publication
(10) Pub. No.: US 2024/0262730 A1
(43) Pub. Date: Aug. 8, 2024

(54) PURE WATER PRODUCTION APPARATUS AND PURE WATER PRODUCTION METHOD

(71) Applicant: ORGANO CORPORATION, Tokyo (JP)

(72) Inventors: Yusuke TAKAHASHI, Tokyo (JP); Kazushige TAKAHASHI, Tokyo (JP); Yuki NAKAMURA, Tokyo (JP)

(73) Assignee: ORGANO CORPORATION, Tokyo (JP)

(21) Appl. No.: 18/567,086

(22) PCT Filed: Jan. 31, 2022
(86) PCT No.: PCT/JP2022/003477

§ 371 Date: Dec. 5, 2023

(30) Foreign Application Priority Data
Jun. 17, 2021 (JP) 2021-101147

(51) Int. Cl. C02F 9/00; C02F 1/32; C02F 1/42; C02F 1/44; C02F 1/68; C02F 1/72; C02F 101/30

(52) U.S. Cl. CPC C02F 9/00; C02F 1/32; C02F 1/42; C02F 1/441; C02F 1/685; C02F 1/722; C02F 2101/30; C02F 2209/20; C02F 2303/18; C02F 2305/023

(57) ABSTRACT

A pure water production apparatus that is economical and that can easily ensure good water quality of treated water is provided. Pure water production apparatus has: sulfur compound addition means for adding a sulfur compound containing a peroxide group to water to be treated that contains organic materials; ultraviolet ray radiation apparatus that irradiates with ultraviolet rays the water to be treated to which the sulfur compound was added; reverse osmosis membrane apparatus through which passes the water to be treated that was irradiated with the ultraviolet rays; and ion exchange resin-filled apparatus through which passes the water to be treated that was treated by reverse osmosis membrane apparatus.

### FIELD OF THE INVENTION

The present application is based on and claims priority from JP2021-101147 filed on Jun. 17, 2021, the disclosure of which is hereby incorporated by reference herein in its entirety.

The present invention relates to a pure water production apparatus and a pure water production method.

### DESCRIPTION OF THE RELATED ART

As high demand for the water quality of pure water becomes ever more evident, in recent years various methods have been studied for decomposing and removing a small amount of organic materials that is contained in pure water. As a typical example of these methods, a process is known of using an ultraviolet ray oxidization treatment to decompose and remove organic materials. JP2008-229417 discloses a technique of adding a sulfur compound containing a peroxide group to water to be treated and thereafter irradiating the water to be treated with ultraviolet rays to decompose and remove organic materials contained in the water to be treated. JP2008-229417 discloses removing the sulfur compound containing the peroxide group that remains in the treated water that was irradiated with ultraviolet rays and thereafter performing a deionization treatment using an apparatus filled with an ion exchange resin. Removal of the sulfur compound in advance can prevent oxidative degradation of the resin in the ion exchange resin-filled apparatus. Methods disclosed for removing the sulfur compound include adding a reducing agent, providing an activated carbon tower, and providing a catalyst tower that carries palladium, platinum, and the like.

### SUMMARY OF THE INVENTION

When activated carbon or a catalyst is used as a means of removing a sulfur compound, the activated carbon or catalyst itself may be degraded by an oxidizing agent and thus adversely affect the water quality of the treated water. When a reducing agent is used, a large amount of the reducing agent is required to reduce the sulfur compound containing the peroxide group that remains in the water that was treated with ultraviolet rays, resulting in an increase in the cost of the agent.

The present invention aims at providing a pure water production apparatus that is economical and that can easily ensure good water quality of treated water.

A pure water production apparatus of the present invention comprises:
sulfur compound addition means for adding a sulfur compound containing a peroxide group to water to be treated that contains organic materials;
an ultraviolet ray radiation apparatus that irradiates with ultraviolet rays the water to be treated to which the sulfur compound was added;
a reverse osmosis membrane apparatus through which passes the water to be treated that was irradiated with the ultraviolet rays; and
an ion exchange resin-filled apparatus through which passes the water to be treated that was treated by the reverse osmosis membrane apparatus.

According to the present invention, it is possible to provide a pure water production apparatus that is economical and that can easily ensure good water quality of treated water.

The above and other objects, features and advantages of the present invention will become apparent from the following description with reference to the accompanying drawings that illustrate examples of the present invention.

### BRIEF DESCRIPTION OF DRAWINGS

FIG. 1A is a schematic view of a pure water production apparatus according to a first embodiment of the present invention; and

FIG. 1B is a schematic view of a pure water production apparatus according to a second embodiment of the present invention.

### DESCRIPTION OF EMBODIMENTS

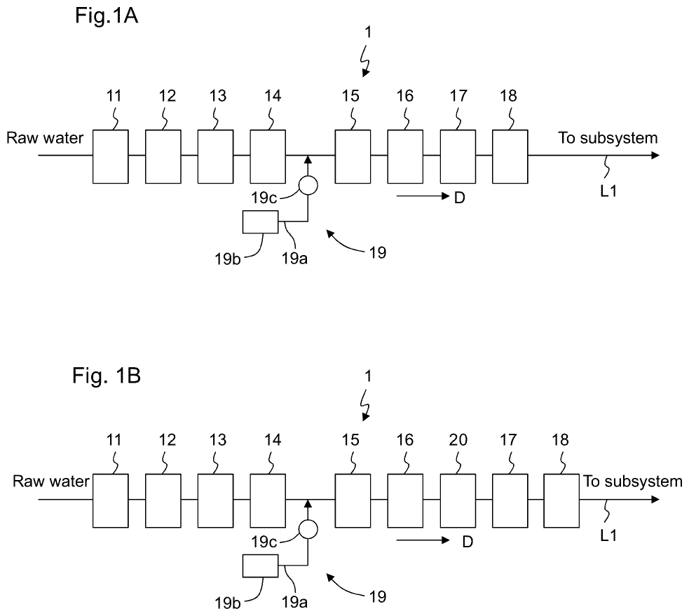

A pure water production apparatus and a pure water production method according to embodiments of the present invention will be described with reference to the drawings. FIG. 1A schematically illustrates the arrangement of pure water production apparatus 1 according to the first embodiment of the present invention. Pure water production apparatus 1 (a primary system) constitutes an ultrapure water production apparatus together with a downstream subsystem (a secondary system). Raw water that is supplied to pure water production apparatus 1 (hereinafter, referred to as water to be treated) contains organic materials.

Pure water production apparatus 1 is provided with raw water tank 11, filter apparatus 12, activated carbon tower 13, ion exchange apparatus 14, ultraviolet ray radiation apparatus (ultraviolet ray oxidization apparatus) 15, reverse osmosis membrane apparatus 16, ion exchange resin-filled apparatus 17 and deaerator apparatus 18, and these apparatuses are arranged along main line L1 in a series in the order listed above from upstream to downstream in direction D of the flow of the water to be treated. The water to be treated that is stored in raw water tank 11 is pressurized by a raw water pump (not illustrated), following which dust and the like having relatively large diameters are removed by filter membrane 12 and impurities such as high-molecular organic materials are removed by activated carbon tower 13. The arrangement of filter membrane 12 is not limited, but a sand filter is used in the present embodiment. Ion exchange apparatus 14 has a cation tower (not illustrated) that is filled with cation exchange resin, a decarbonation tower (not illustrated), and an anion tower (not illustrated) that is filled with anion exchange resin, and these towers are arranged in a series in the order listed above from upstream to downstream. The water to be treated is subjected to cation component removal by the cation tower, carbonic acid removal by the decarbonation tower, and anion component removal by the anion tower.

Sulfur compound addition means 19 is provided between ion exchange apparatus 14 and ultraviolet ray radiation apparatus 15 and adds a sulfur compound containing a peroxide group (hereinafter may be simply referred to as a sulfur compound) to the water to be treated. Sulfur compound addition means 19 has sulfur compound addition line 19a, sulfur compound storage tank 19b that is connected to one end of addition line 19a, and sulfur compound transfer pump 19c. The other end of addition line 19a is connected to main line L1 between ion exchange apparatus 14 and ultraviolet ray radiation apparatus 15. Examples of the sulfur compound containing a peroxide group include sodium peroxydisulfate (Na₂S₂O₈), ammonium peroxydisulfate ((NH₄)₂S₄O₈), and potassium peroxydisulfate (K₂S₂O₈), and these compounds are used alone or in combination.

The ratio of the concentration of the sulfur compound to the TOC (hereinafter referred to as a concentration ratio) in the water to be treated (more precisely, the TOC in the water to be treated in the section between the connection of addition line 19a to main line L1 and ion exchange apparatus 14) is preferably about 50 to 5000. If the concentration ratio is less than 50, then sulfuric acid radicals are not generated sufficiently and the efficiency of decomposing organic materials in the water to be treated decreases. If the concentration ratio is more than 5000, the concentration of residual sulfur compound that is not used to decompose the organic materials increases and the sulfur compound is used pointlessly. In addition, the concentration of the sulfur compound in the treated water of reverse osmosis membrane apparatus 16 increases, resulting in increased risk of damage to ion exchange resin-filled apparatus 17.

Ultraviolet ray radiation apparatus 15 irradiates the water to be treated with ultraviolet rays. Ultraviolet ray radiation apparatus 15 may have an ultraviolet ray lamp that includes a wavelength of, for example, at least any one of 365 nm, 254 nm, 185 nm, and 172 nm. The irradiation of ultraviolet rays causes the sulfur compound containing the peroxide group to generate sulfuric acid radicals in the water to be treated. Sulfuric acid radicals decompose organic materials at a higher rate than, for example, hydroxy radicals that are generated by irradiating water with ultraviolet rays, and efficiently decompose the organic materials contained in the water to be treated.

Reverse osmosis membrane apparatus 16 removes the residual sulfur compound containing the peroxide group in the treated water of ultraviolet ray radiation apparatus 15. The sulfur compound containing the peroxide group is highly oxidative. Therefore, supplying the treated water of ultraviolet ray radiation apparatus 15 that contains a highly concentrated sulfur compound to ion exchange resin-filled apparatus 17 will result in oxidative degradation of the ion exchange resin and thus cause elution of organic materials and an increase in the TOC in the treated water of ion exchange resin-filled apparatus 17. In the present embodiment, water to be treated in which the concentration of the sulfur compound has been reduced is supplied to ion exchange resin-filled apparatus 17, and increase in the TOC in the treated water of ion exchange resin-filled apparatus 17 is therefore prevented.

Ion exchange resin-filled apparatus 17 is a regenerative ion exchange resin tower that is filled with anion exchange resin and cation exchange resin. Decomposition products of the organic materials that are generated in the water to be treated by the radiation of ultraviolet rays are removed by ion exchange resin-filled apparatus 17. Thereafter, dissolved oxygen, carbonic acid, and the like in the water to be treated are removed by deaerator apparatus 18. Although not illustrated, an electro-deionization apparatus (EDI) may be provided instead of ion exchange resin-filled apparatus 17. An EDI does not require a process of regenerating ion exchangers because an EDI continuously regenerates the ion exchangers.

The sulfur compound containing the peroxide group is an oxidizing agent and causes oxidative degradation of the resin in ion exchange resin-filled apparatus 17. Therefore, the sulfur compound is removed from the water to be treated before the water to be treated is supplied to ion exchange resin-filled apparatus 17. The sulfur compound can be removed not only by reverse osmosis membrane apparatus 16 but also by activated carbon, catalyst-carrying platinum group metals, and the like. However, in the case of the activated carbon and the catalyst, the activated carbon and the catalyst themselves may be degraded by oxidization and may degrade the water quality. However, the inventors found that the manner of the oxidative degradation differs depending on the means of removing the sulfur compound and that reverse osmosis membrane apparatus 16 is less likely to be affected by oxidative degradation.

The inventors further found that ion exchange resin-filled apparatus 17 is more easily affected by the oxidative degradation caused by the sulfur compound than reverse osmosis membrane apparatus 16 but that ion exchange resin-filled apparatus 17 is less likely to be affected by the oxidative degradation if the concentration of the sulfur compound is sufficiently low. As will be described in the examples, the concentration of the sulfur compound in the treated water of reverse osmosis membrane apparatus 16, that is, the inlet water of ion exchange resin-filled apparatus 17, is preferably 0.5 mg/L or less. Thus, it is possible to prevent the oxidative degradation of the ion exchange resin and to efficiently remove ionized organic materials. If the concentration of the sulfur compound exceeds 0.5 mg/L, the possibility increases that the TOC will increase due to the oxidative degradation of the ion exchange resin and that the water quality of the treated water will be adversely affected. An increase in the TOC in the treated water that is caused by the oxidative degradation of the resin of ion exchange resin-filled apparatus 17 can be limited by using reverse osmosis membrane apparatus 16 to reduce the concentration of the sulfur compound to 0.5 mg/L or less. The concentration of the sulfur compound in the water to be treated that is supplied to ion exchange resin-filled apparatus 17 may be reduced to 0.5 mg/L or less by, for example, a method of controlling at least one of the amount of the sulfur compound added by sulfur compound addition means 19, the operation conditions (the recovery rate, etc.) of reverse osmosis membrane apparatus 16, and the operation conditions (the amount of radiation, etc.) of ultraviolet ray radiation apparatus 15 based on at least one of the TOC in the water that is supplied to ultraviolet ray radiation apparatus 15, the TOC in the treated water of ultraviolet ray radiation apparatus 15, the concentration of the sulfur compound in the water that is supplied to reverse osmosis membrane apparatus 16, and the concentration of the sulfur compound in the water that is supplied to ion exchange resin-filled apparatus 17. The control may be realized using one or a combination of the above-mentioned TOCs and the concentrations of the sulfur compound. The method of obtaining the concentration of the sulfur compound is not limited, but this concentration may be obtained, for example, by measuring the conductivity by a conductivity meter and converting this value to the concentration of the sulfur compound. For example, the conductivity that is measured by the conductivity meter may be converted to the concentration of the sulfur compound based on a relationship obtained in advance between the conductivity and the concentration of the sulfur compound. The control may be conducted by a predetermined control unit (not illustrated).

The sulfur compound may be removed by adding a reducing agent such as sodium bisulfite. However, the reducing agent must be continuously supplied to the inlet water of ion exchange resin-filled apparatus 17, and this use of the agent consequently results in both an increase in cost of the agent and an increase of the ion load and thus necessitates more frequent regeneration of the ion exchange resin of ion exchange resin-filled apparatus 17.

Due to the novel arrangement in which reverse osmosis membrane apparatus 16 is used to remove the sulfur compound containing the peroxide group in the present embodiment, pure water production apparatus 1 can limit the oxidative degradation of the resin of ion exchange resin-filled apparatus 17 and can limit the operation cost (cost of the agent).

The concentration of the sulfur compound in the water to be treated that is supplied to reverse osmosis membrane apparatus 16 is not limited but is preferably 400 mg/L or less, and from the viewpoint of limiting the load on ion exchange resin-filled apparatus 17, the concentration is more preferably 100 mg/L or less and still more preferably 20 mg/L or less. If the concentration of the sulfur compound exceeds 400 mg/L, oxidative degradation of reverse osmosis membrane apparatus 16 may occur, and the load on ion exchange resin-filled apparatus 17 may also increase. The concentration of the sulfur compound in the water to be treated that is supplied to reverse osmosis membrane apparatus 16 may be reduced to 400 mg/L or less by, for example, controlling at least one of the amount of the sulfur compound added by sulfur compound addition means 19, the operation conditions (the recovery rate, etc.) of reverse osmosis membrane apparatus 16, and the operation conditions (the amount of radiation, etc.) of ultraviolet ray radiation apparatus 15 based on at least one of the TOC in the water that is supplied to ultraviolet ray radiation apparatus 15, the TOC in the treated water of ultraviolet ray radiation apparatus 15, the concentration of the sulfur compound in the water that is supplied to reverse osmosis membrane apparatus 16, and the concentration of the sulfur compound in the water that is supplied to ion exchange resin-filled apparatus 17. The control may be realized by using one or a combination of the above-mentioned TOCs and the concentrations of the sulfur compound. The method of obtaining the concentration of the sulfur compound is not limited, but, for example, the conductivity that is measured by a conductivity meter may be converted to the concentration of the sulfur compound. For example, the conductivity that is measured by the conductivity meter may be converted to the concentration of the sulfur compound based on a relationship obtained in advance between the conductivity and the concentration of the sulfur compound. The control may be conducted by a predetermined control unit (not illustrated).

FIG. 1B schematically illustrates the arrangement of pure water production apparatus 1 according to the second embodiment of the present invention. Pure water production apparatus 1 according to the present embodiment is the same as pure water production apparatus 1 according to the first embodiment except that sulfur compound removal means 20 for removing sulfur compound that contains the peroxide group is provided between reverse osmosis membrane apparatus 16 and ion exchange resin-filled apparatus 17. Reference should be made to the description of the first embodiment regarding the arrangement and effects not here described. The type of sulfur compound removal means 20 is not limited and various means that are generally used to remove an oxidizing agent such as a reducing agent, activated carbon, and a catalyst-carrying platinum group metal may be used.

Sulfur compound removal means 20 is preferably provided between reverse osmosis membrane apparatus 16 and ion exchange resin-filled apparatus 17. Sulfur compound removal means 20 may also be provided between ultraviolet ray radiation apparatus 15 and reverse osmosis membrane apparatus 16, in which case the load on sulfur compound removal means 20 increases. If sulfur compound removal means 20 is activated carbon or a catalyst, oxidation caused by the sulfur compound may degrade the activated carbon or the catalyst and substances such as TOC components may leak into the treated water and thus adversely affect the water quality of the treated water. If sulfur compound removal means 20 is a reducing agent, the amount of the added reducing agent may increase, resulting in an increase of the cost of the agent. Because most of the sulfur compound is removed by reverse osmosis membrane apparatus 16 and the residual sulfur compound then removed by sulfur compound removal means 20 in the present embodiment, the performance of pure water production apparatus 1 is improved and the operation cost is limited.

Although embodiments of the present invention have been described, the present invention is not limited to these embodiments. For example, means for adding metal ions may be provided upstream of ultraviolet ray radiation apparatus 15. Other than the exclusion of alkali metals, metal ions are not limited and examples of the metal ions include ions of iron, copper, silver, gold, and manganese. The presence of the metal ions in the water to be treated promotes the activation of the sulfur compound and improves the performance of treating organic materials.

In addition, the concentration of the sulfur compound in the treated water of ultraviolet ray radiation apparatus 15 may vary depending on the TOC in the inlet water of ultraviolet ray radiation apparatus 15. Specifically, when the TOC in the inlet water of ultraviolet ray radiation apparatus 15 is low, a larger amount of the sulfur compound may flow out of ultraviolet ray radiation apparatus 15 without being consumed. When the concentration of the sulfur compound is increased to improve the decomposition efficiency of organic materials, the concentration of the sulfur compound in the treated water of ultraviolet ray radiation apparatus 15 may also increase. In these cases, two or more reverse osmosis membrane apparatuses 16 may be arranged in a series to limit the oxidative degradation of the resin of ion exchange resin-filled apparatus 17. In other words, second reverse osmosis membrane apparatus (not illustrated) may be provided between reverse osmosis membrane apparatus 16 and ion exchange resin-filled apparatus 17. Providing reverse osmosis membrane apparatuses 16 in a series allows an improvement of the performance of removing the sulfur compound and a reduction of the load on ion exchange resin-filled apparatus 17. In the second embodiment, sulfur compound removal means 20 may be arranged between reverse osmosis membrane apparatuses 16 that are arranged in a series.

### EXAMPLES

### Example 1

Potassium peroxydisulfate (K₂S₂O₈) was added at 10 mg/L to water to be treated that contained 80 μg/L of urea, the water to be treated was irradiated with ultraviolet rays by an ultraviolet ray radiation apparatus with an output of 0.73 kWh/m³, following which the water to be treated was supplied to and treated by a reverse osmosis membrane apparatus (ESPA2-4040, manufactured by Nitto Denko Corporation). The flow rate of the reverse osmosis membrane apparatus was 1.0 m³/h, the flow rate of the treated water of the reverse osmosis membrane apparatus was 200 L/h, and the flow rate of the condensed water was 800 L/h. The treated water of the reverse osmosis membrane apparatus was supplied to an ion exchange resin-filled apparatus (the resin was ESP-2, manufactured by Organo Corporation) at SV 120 (/h), and the concentration of K₂S₂O₈ and the TOC in the inlet water of the ion exchange resin-filled apparatus and the concentration of urea and the TOC in the treated water of the ion exchange resin-filled apparatus were measured.

### Example 2

In Example 1, K₂S₂O₈ was added at 40 mg/L and measurement was conducted under the same conditions.

### Example 3

In Example 1, a reducing agent was added to the treated water of the reverse osmosis membrane apparatus and the treated water was supplied to the ion exchange resin-filled apparatus. Sodium sulfite (Na₂SO₃) was used as the reducing agent, and a mass of sodium sulfite equivalent to twice the concentration of the peroxydisulfuric acid in the treated water of the reverse osmosis membrane apparatus was added.

### Example 4

In Example 1, a reducing agent was added to the treated water of the ultraviolet ray radiation apparatus and the treated water was supplied to and treated by the reverse osmosis membrane apparatus and then by the ion exchange resin-filled apparatus. Na₂SO₃ was used as the reducing agent, and a mass of Na₂SO₃ equivalent to twice the concentration of the peroxydisulfuric acid in the treated water of the reverse osmosis membrane apparatus was added.

### Comparative Example 1

In Example 1, the treated water of the ultraviolet ray radiation apparatus was not supplied to the reverse osmosis membrane apparatus but was supplied to the ion exchange resin-filled apparatus.

Table 1 summarizes the measurements. In Comparative Example 1, the TOC in the treated water was high. The reason for this is believed to be that residual peroxydisulfuric acid in the ultraviolet ray radiation apparatus caused oxidative degradation of the ion exchange resin. In Example 1, which adopted an arrangement in which a reverse osmosis membrane apparatus was provided in Comparative Example 1, the TOC in the treated water was less than 1 μg/L. The reason here is believed to be that the concentration of the peroxydisulfuric acid was reduced to 0.1 mg/L by the reverse osmosis membrane apparatus and the oxidative degradation of the ion exchange resin was therefore limited. In Example 2, the concentration of the peroxydisulfuric acid in the inlet water of the ion exchange resin-filled apparatus was 0.5 mg/L, but the TOC in the treated water of the ion exchange resin-filled apparatus was 1 μg/L, which was less than in Comparative Example 1. The reason is believed to be that the elution of the ion exchange resin was small, and the influence of the oxidative degradation was limited. Therefore, when the concentration of the sulfur compound in the water to be treated that is supplied to the ion exchange resin-filled apparatus is 0.5 mg/L or less, the water quality of the treated water is considered to be not greatly affected. In Examples 3 and 4, in which a reducing agent was added, the same treatment performance was obtained, but a larger amount of the reducing agent had to be used when the reducing agent was added upstream of the reverse osmosis membrane apparatus (Example 4) than when the reducing agent was added downstream of the reverse osmosis membrane apparatus (Example 3). Thus, it was found that the reducing agent is preferably added downstream of the reverse osmosis membrane apparatus.

TABLE 1

| | | | | | Treated water of the | |
|---|---|---|---|---|---|---|
| | | Inlet water of the ion exchange | | | ion exchange resin- | |
| | Concentration | resin-filled apparatus | | | filled apparatus | |
| | of reducing | Peroxydisulfuric | TOC | Urea | TOC | Urea |
| | agent (mg/L) | acid (mg/L) | (μg/L) | (μg/L) | (μg/L) | (μg/L) |
| Example 1 | — | 0.1 | <1 | 2 | <1 | 2 |
| Example 2 | — | 0.5 | <1 | 1 | 1 | 1 |
| Example 3 | 0.1 | <0.1 | <1 | 2 | <1 | 2 |
| Example 4 | 6 | <0.1 | <1 | 2 | <1 | 2 |
| Comp. | — | 4 | <1 | 3 | 6 | 3 |
| Example 1 | | | | | | |

### Example 5

Water to be treated that was produced by adding 5 mg/L of NaCl, 100 μg/L of IPA, and 400 mg/L of K₂S₂O₈ to pure water was supplied to a reverse osmosis membrane apparatus (ESPA2-4040, manufactured by Nitto Denko Corporation) for 800 hours, and the permeability coefficient, the differential pressure of the membrane ((the pressure of the raw water+the pressure of the condensed water)/2−the pressure of the permeated water), and the rejection rates for Na, Cl, and IPA of the reverse osmosis membrane apparatus were obtained after the passage of 800 hours. The rejection rate can be calculated as {(the concentration in the raw water+the concentration in the condensed water)/2−the concentration in the permeated water}/{(the concentration in the raw water+the concentration in the condensed water)/2}×100. An acceleration test was conducted by setting the concentration of K₂S₂O₈ to 4000 times that of Example 1 and 800 times that of Example 2 in order to evaluate a time span of the same order as the replacement interval of a reverse osmosis membrane apparatus. The flow rate of the reverse osmosis membrane apparatus was 1 m³/h, the flow rate of the treated water of the reverse osmosis membrane apparatus was 200 L/h, and the flow rate of the condensed water was 800 L/h. Table 2 summarizes the results. The results do not confirm any tendency indicating degradation of each value after the passage of 800 hours. Thus, it was found that when the concentration of K₂S₂O₈ is 400 mg/L or less, the performance of the reverse osmosis membrane apparatus is not adversely affected.

TABLE 2

| Water | Permeability | Differential | | | |
|---|---|---|---|---|---|
| supply time | coefficient | pressure of | Rejection rate (%) | | |
| (h) | (m/d/MPa) | membrane (MPa) | Na | Cl | IPA |
| 0 | 1.5 | 0.4 | 99 | 99.9 | 88 |
| 200 | 1.5 | 0.4 | 99 | 99.9 | 87 |
| 340 | 1.5 | 0.4 | 99 | 99.9 | 88 |
| 420 | 1.5 | 0.4 | 99 | 99.9 | 89 |
| 800 | 1.5 | 0.4 | 99 | 99.9 | 90 |

The above and other objects, features, and advantages of the present invention will become apparent from the following description with reference to the accompanying drawings that illustrate examples of the present invention.

### LIST OF REFERENCE NUMERALS

1 pure water production apparatus
11 raw water tank
12 filter apparatus
13 activated carbon tower
14 ion exchange apparatus
15 ultraviolet ray radiation apparatus
   (ultraviolet ray oxidization apparatus)
16 reverse osmosis membrane apparatus
17 ion exchange resin-filled apparatus
18 deaerator apparatus
19 sulfur compound addition means
20 sulfur compound removal means

1. A pure water production apparatus comprising:
sulfur compound addition means for adding a sulfur compound containing a peroxide group to water to be treated that contains organic materials;
an ultraviolet ray radiation apparatus that irradiates with ultraviolet rays the water to be treated to which the sulfur compound was added;
a reverse osmosis membrane apparatus through which passes the water to be treated that was irradiated with the ultraviolet rays; and
an ion exchange resin-filled apparatus through which passes the water to be treated that was treated by the reverse osmosis membrane apparatus.

2. The pure water production apparatus according to claim 1, wherein concentration of the sulfur compound in the water to be treated that is supplied to the ion exchange resin-filled apparatus is 0.5 mg/L or less.

3. The pure water production apparatus according to claim 2, further comprising a control unit,
wherein the control unit controls at least one of:
an amount of the sulfur compound added by the sulfur compound addition means,
an operation condition of the reverse osmosis membrane apparatus, and
an operation condition of the ultraviolet ray radiation apparatus
based on at least one of:
TOC in water that is supplied to the ultraviolet ray radiation apparatus,
TOC in treated water of the ultraviolet ray radiation apparatus,
concentration of the sulfur compound in water that is supplied to the reverse osmosis membrane apparatus, and
concentration of the sulfur compound in water that is supplied to the ion exchange resin-filled apparatus
such that the concentration of the sulfur compound in the water to be treated is 0.5 mg/L or less.

4. The pure water production apparatus according to claim 1, further comprising sulfur compound removal means between the reverse osmosis membrane apparatus and the ion exchange resin-filled apparatus.

5. The pure water production apparatus according to claim 1, wherein concentration of the sulfur compound in the water to be treated that is to be treated by the reverse osmosis membrane apparatus is 400 mg/L or less.

6. The pure water production apparatus according to claim 5, further comprising a control unit,
wherein the control unit controls at least one of:
an amount of the sulfur compound added by the sulfur compound addition means,
an operation condition of the reverse osmosis membrane apparatus, and
an operation condition of the ultraviolet ray radiation apparatus
based on at least one of:
TOC in water that is supplied to the ultraviolet ray radiation apparatus,
TOC in treated water of the ultraviolet ray radiation apparatus,
concentration of the sulfur compound in water that is supplied to the reverse osmosis membrane apparatus, and
concentration of the sulfur compound in water that is supplied to the ion exchange resin-filled apparatus
such that the concentration of the sulfur compound in the water to be treated that is to be treated by the reverse osmosis membrane apparatus is 400 mg/L or less.

7. The pure water production apparatus according to claim 1, further comprising a second reverse osmosis membrane apparatus that is provided between the reverse osmosis membrane apparatus and the ion exchange resin-filled apparatus.

8. A pure water production method comprising:
adding a sulfur compound containing a peroxide group to water to be treated that contains organic materials;
irradiating with ultraviolet rays the water to be treated to which the sulfur compound was added;
passing the water to be treated that was irradiated by the ultraviolet rays through a reverse osmosis membrane apparatus; and
supplying the water to be treated that was treated by the reverse osmosis membrane apparatus to an ion exchange resin-filled apparatus.
